(19) United States
(12) Patent Application Publication
(10) Pub. No.: US 2010/0021863 A1
(43) Pub. Date: Jan. 28, 2010

(54) Dental Retractor

(76) Inventor: Brad Braman, Bend, OR (US)

Correspondence Address: DONN K. HARMS;PATENT & TRADEMARK LAW CENTER, SUITE 100, 12702 VIA CORTINA, DEL MAR, CA, 92014, US

(21) Appl. No.: 12/342,632

(22) Filed: Dec. 23, 2008

Related U.S. Application Data
(60) Provisional application No. 61/083,073, filed on Jul. 23, 2008.

(51) Int. Cl. A61C 3/00

(52) U.S. Cl. 433/140

(57) ABSTRACT

A dental retractor for employment during dental and oral surgery procedures. The device employs a reflective surface at a distal end which is conventionally used adjacent to the surgery site in the patient's mouth. The reflective surface eliminates the need for additional mirrors and such in the patient's mouth. Additionally provided is a proximal end that will adapted for ergonomic positioning in the hand of the user.

This application claims the benefit of priority from U.S. Provisional Patent Application Ser. No. 61/083,073 filed Jul. 23, 2008, which is incorporated herein in its entirety by reference.

### FIELD OF THE INVENTION

The disclosed device relates to instruments employed in dental surgery. More particularly, it relates to a dental retractor which includes a reflective surface at a distal end adjacent to the surgery site in the patient's mouth. Additionally, it includes means for adjusting the proximate end for ergonomic positioning for the user.

### BACKGROUND OF THE INVENTION

Dental surgery, especially in the rear portions of the mouth, is conducted in the narrow confines of that mouth with dental instruments which must be employed with great precision by the medical professional using them. As a consequence, it has become conventional during such procedures to employ retractors to expand the area employable to manipulate instruments. Further, such retractors are also deployed during surgeries to allow the dental surgeon a better view of the intended surgery site.

Consequently, the surgeon, and frequently the assistant to the surgeon, manipulate a number of surgical instruments within the mouth of the patient concurrently, much to the chagrin of the patient. In procedures where gums or teeth are being treated, the use of a dental retractor to move the cheeks out of the way to provide more space for other instruments is common. The retractors are engaged as a pointed distal end with the teeth or gums and then employed to pry or bias the cheek of the patient out of the way. The cheek of the patient is a muscular portion of the face and the skin is generally tight anyway, so it takes a good deal of force to move the cheek and lips and tongue out of the way, and maintain them in this position for the duration of the surgery. This can have a fatiguing effect on the surgeon or assistant assigned the task of imparting that force and maintaining it using their fingers, hand and arm. It is thus important that the proximate end of the retractor is comfortable to hold over long surgeries, and also of a shape that is ergonomic so as not to cause injury or fatigue to the person tasked with holding it for the surgeon.

As noted, the field can become very crowded due to the inherent limit of space provided by the area of the mouth. Numerous instruments such as drills, curing lights, mirrors, gum retractors, sutures, and other devices may be required at any given time during a surgery. Consequently, it would be an advantage if surgical instruments might be combined to reduce the number of instruments having to occupy the mouth at any given time. Frequently, one such instrument is a mirror employed by the surgeon to view a side edge or back side of a tooth or gum portion of the mouth being worked upon.

As such, there exists an unmet need for a device and system to combine a retractor with a reflective surface to eliminate the need for two separate instruments in the patient's mouth. Such a system should provide for a mirrored surface at the distal end of the retractor which will accommodate the surgeon's eyesight. Additionally, such a device should more easily image the area of the mouth which the surgeon desires to view during a procedure through the provision of an angle adjustment of the mirror and image magnification if needed. Still further, such a device and system should provide optionally for additional illumination if needed especially in combination with the mirror for imaging.

An additional improvement in such a device may also include a means for suction combined with the retractor and mirrored surface at the distal end of the retractor. Such a combination will not only place the mirrored surface adjacent to the patient's teeth, it will maintain the level of liquid in the mouth at the site at a level below that of the mirror being employed to concurrently view the work being performed by the surgeon.

In this respect, before explaining at least one embodiment of the invention in detail, it is to be understood that the invention is not limited in its application to the details of construction and to the arrangement of the components set forth in the following description or illustrated in the drawings nor the steps outlined in the specification. The invention is capable of other embodiments and of being practiced and carried out in various ways as those skilled in the art will readily ascertain from reading this application. Also, it is to be understood that the phraseology and terminology employed herein are for the purpose of description and should not be regarded as limiting.

As such, those skilled in the art will appreciate that the conception upon which this disclosure is based may readily be utilized as a basis for designing other methods and systems for carrying out the several purposes of the present invention of a device which is a significant improvement to dental retraction instruments. It is important, therefore, that the claims be regarded as including such equivalent construction insofar as they do not depart from the spirit and scope of the present invention.

### OBJECTS OF THE INVENTION

An object of this invention is the provision of a dental retractor which has a reflective surface employable at a distal end.

An additional object of this invention is the provision of such a retractor which may be assembled from multiple components with ease to allow adjustment of the optics of the imaging mirror to the user's preference.

Yet another object of this invention is to provide a dental retraction device which is ergonomic in application and use to spare the user discomfort and even injury over long term use.

Yet another object of this invention is the provision of such a retractor with a reflective distal end in a kit form wherein the optics or the reflective surface may be adjusted as needed.

Another object of this invention is to provide such a retractor which optionally may provide a light source while in the mouth focused on the area being imaged to enhance the reflection in the reflective surface.

Yet another object of this invention would be to provide a reflective surface for a dental retractor which will allow retrofitting of the millions of retractors currently employed and provide customizable imaging through adhesive backed mirrored surfaces which may be adhered with different viewing-angle and imaging qualities.

These together with other objects and advantages which will become subsequently apparent reside in the details of the construction and operation as more fully hereinafter described and claimed, reference being had to the accompanying drawings forming a part thereof, wherein like numerals refer to like parts throughout.

### SUMMARY OF THE INVENTION

The device herein and method of forming the device herein from engageable components, provides a novel and useful dental retractor which concurrently provides a mirror or optically reflective surface. Consequently, it may take the place of two instruments which must currently occupy the crowded field in an oral surgery or during a cosmetic or other procedure in the mouth of a patient.

While depicted as a curvilinear generally planar retractor, the device capable of other shapes and consequently the drawings should not limit the scope of the claims in any fashion since those skilled in the art, reading this disclosure, will surely discern other modes of the device using the principles herein. All such modes of the device employing a different shape to the elongated retractor as would occur to those skilled in the art are anticipated as well as any employment of another engageable reflective surface.

As depicted in the figures of the drawings the device features an elongated member having a pointed distal end adapted for engagement between teeth or teeth and gums. With the distal end so engaged, the proximate end may be biased or forced against the edge of the mouth of the patient to move the cheek and/or the tongue away from the field of view of the surgeon of the operative site and thereby improve and enlarge the field of view during surgery.

All modes of the device employ a reflective surface which is engaged at the distal end of the retractor adjacent to the pointed or engagement edge. Thereby positioned, a reflective surface will be adapted to reflect the area of the mouth on which the surgeon is operating.

The reflective surface may be permanently engaged at the distal end of the retractor for new instruments. Or, in a particularly preferred mode of the device, a reflective surface may be temporarily engaged to the retractor thereby providing a reflective means which includes means to adapt the optical characteristics of the reflected image to the work at hand. If permanently engaged, the reflective surface may be adapted to reflect an image in a one to one reflection, or may be adapted to enlarge the image reflected or provide a wide angle view of the area reflected. The shape and optical characteristics of the mirrored surface, and angle of engagement of the surface to that of the retractor will determine the ultimate nature of the refection viewed.

If provided in a removably engageable mode, the reflective surface employed for each individual surgery may be adapted to provide customized reflective optics for the job at hand. Using adhesive or other means of temporary engagement to the distal end, a reflective surface may be engaged that is variable for its reflective properties. Such properties may include angle, magnification properties, wide angle properties, or might be a split image with two angles reflecting two portions of the area adjacent to the distal end of the retractor. In this removably engageable mode, the device in a particularly preferred mode would be provided as surfaces which may be purchased from catalogs or online sites which provide the desired reflective property of the surgeon, or in an especially preferred mode in kits of engageable reflective surfaces. Such kits would be provided with a plurality of different reflective surfaces with each being engageable to the distal end of the retractor surface. Members of the kit would include individual reflective surfaces each having a different optical reflective characteristic and may also include members each having one of a plurality of angles of engagement or the reflective surface relative to the surface of the retractor to which it is engaged. The user would choose the appropriate type of reflective surface for their individual needs and engage it thereby customizing the reflected image for the user such as the surgeon.

With the ever smaller illumination means, and safe low voltage provided by modern LED's, the device in one mode may provide illumination directed at the area of the mouth to be reflected, to better provide the user with a reflection in the reflective surface that may be seen in an otherwise dark mouth. This can be done by directing the light onto the reflective surface toward the site being reflected, or toward the site being reflected directly or in a combination thereof.

In another particularly preferred mode of the device featuring additional utility, the proximate end of the retractor held by the user or an assistant, is formed in a shape, and at an orientation to the user's hand, which makes it more ergonomic and comfortable to employ over long periods of time. Currently, this means for ergonomic adjustment of the proximate end is provided by a pivot centrally located between the distal and proximate ends which allows the user to rotate the grip on the proximate end to a comfortable orientation.

Still further, a means for suction of liquid collecting in the mouth adjacent to the site of the surgery and distal end of the retractor may be provided in another preferred mode of the device. Such a liquid collection would employ a conduit on the retractor or through the body of the retractor which communicates with an aperture at the distal end of the retractor. The aperture would have a position on the retractor such that when the retractor is in the as-used position, engaged with the patient's mouth at its distal end, the aperture would be lower than the reflective surface in the mouth. Since fluid seeks its own level, and the aperture for collection is lower than the reflective surface, suction engaged to the conduit will serve to maintain fluid in the mouth, below the level of the mirrored surface and thereby maintain it in a viewable manner for the surgeon.

The device may be provided with one or all of the components of the reflective surface, illumination means, pivot, and means for suction of fluids from the mouth, depending on how much of an increase in utility is desired. However, each addition in combination with the reflective surface will in itself provide a great improvement on available dental retractors.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Therefore, the foregoing description and following detailed description are considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

### BRIEF DESCRIPTION OF THE DRAWINGS

FIG. 1 shows a perspective view of a the device with the reflective surface positioned at a distal end on a rear surface.

FIG. 1a depicts the rear surface of the device of FIG. 1 showing the reflective surface and optional illumination means and suction components.

FIG. 2 depicts the retractor device of FIG. 1 with an addition of a pivot as a means to ergonomically adjust the position of the proximate end and having the reflective surface on the front surface of the distal end.

FIG. 3 depicts the device with the proximate end rotated around the axis of the pivot to adjust the proximate end ergonomically.

FIG. 4 shows the reflective surface in a removably engageable mirror.

FIG. 5 depicts a side view of the removably engageable mirror showing a peel and stick adhesive back.

FIG. 6 depicts the reflective surface having a rear side which angles the surface at a different angle than the planar surface of the retractor.

FIG. 7 shows another means for removable engagement in the form of a bayonet type mount on the back surface of the mirror and a receiving cavity on the distal end of the retractor.

### DETAILED DESCRIPTION OF THE INVENTION

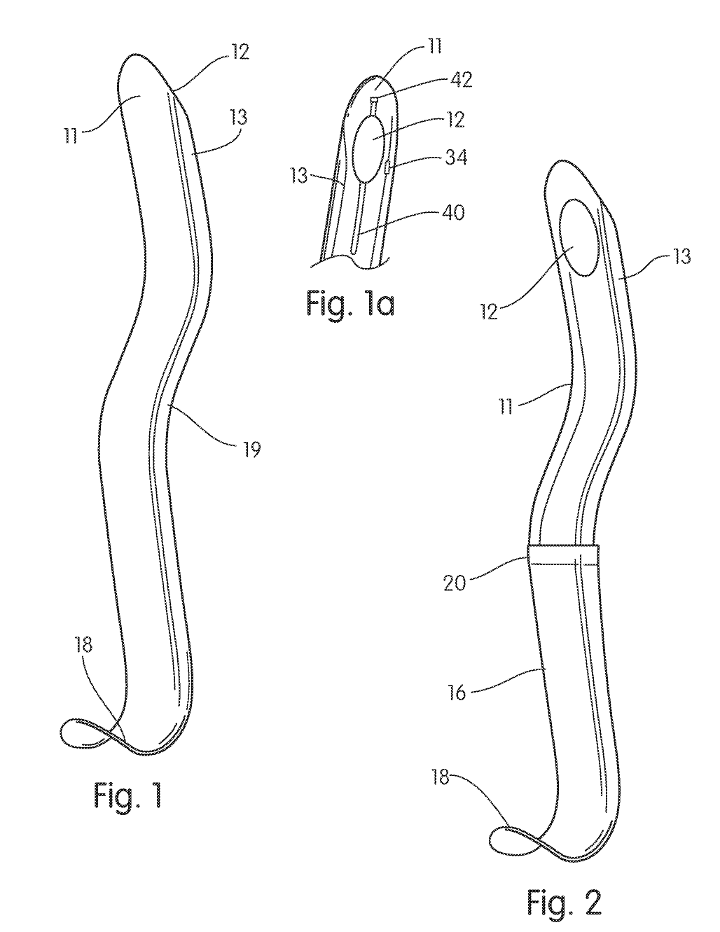

Referring now to the drawings in FIGS. 1-7, wherein similar parts are identified by like reference numerals, there is seen in FIG. 1 a perspective view of the device 10 as would be provided with a dental retractor 14 body. As shown in FIG. 1a, an engaged reflective surface 12 is positioned at a distal end 11 of the dental retractor 14 in between stiffening sidewalls 13. The distal end 11 is somewhat pointed to allow engagement between teeth or gums or other areas of the mouth and allow the user a point from which to apply force with the proximate end 16 to move the cheek and lips out of the way during a surgery.

At the proximate end 16 is formed a curved portion 18 adapted for the engagement of the fingers of the user during employment of the retractor 14 in a surgery. In a first preferred mode of the device, shown in FIGS. 1 and 1a, during a surgery the device 10 is placed in an as-used position by positioning the distal end 11 at the proper position in the mouth to retract the cheek, gums, or tongue as needed. Subsequently, the proximate end 16 biased or forced by the hand of the user on the curved portion 18 allowing the user to move the cheek, tongue, or other portion of the mouth to the desired position. The reflective surface 12 is positioned to provide the surgeon a reflective view of the image of the portion of the mouth adjacent to the distal end 11.

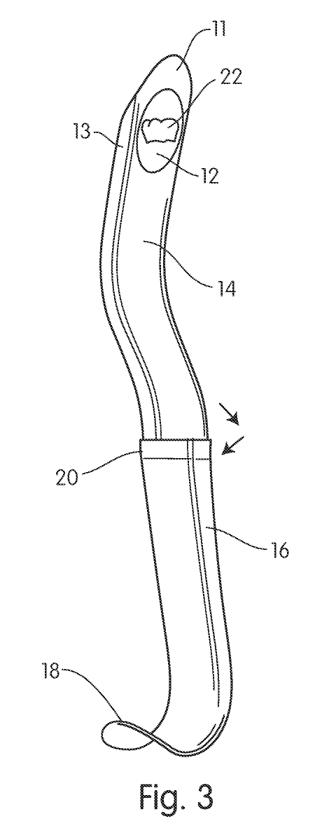

FIG. 2 depicts an especially preferred mode of the device 10 wherein the retractor 14 has an optional pivot 20 centrally located between the distal end 11 and proximate end 16. The pivot 20 allows the user to rotate the proximate end 16 for comfort and ergonomic concerns of the hand while in use as the retractor 14 may be required to be placed in awkward positions relative to the user's hand position. The pivot 20 operates as a means to ergonomically position the proximate end 16 by allowing the user to first properly position and angle the reflective surface 12 to show a view of the mouth desired, and then, pivot the proximate end 16 to a comfortable position for their fingers and hand which grip the proximate end 16 at the curved portion 18. This can be seen as an example in FIG. 3 which depicts the device 10 wherein the proximate end 16 has been rotated around the axis of the pivot 20 to adjust the proximate end ergonomically. This is especially preferred to aid dental assistants and surgeons in avoiding cramping and discomfort over a long time period frequently required for a surgery.

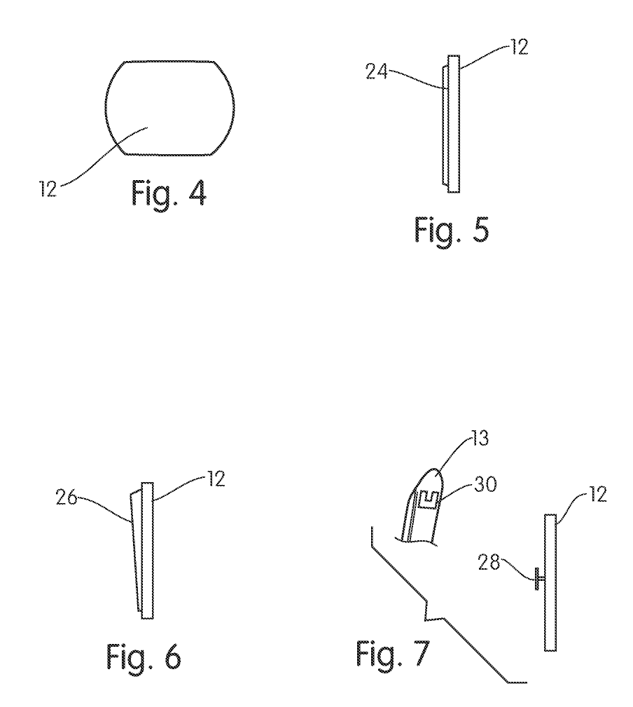

FIGS. 4-7 show modes of the reflective surface 12 configured for removable engagement of the reflective surface 12 such as a mirror. Using removably engageable reflective surfaces 12 as noted, provides the user with great utility by the provision of a means to adjust the optical image reflective characteristics of the reflected image 22 shown in FIG. 3 as a tooth.

As shown in FIG. 5 means for removable engagement of the reflective surface 12 may be provided by an adhesive back 24 or other means of removable engagement may be employed such as hook and loop fabric, a mechanical engagement such as a slide, or any such means for removable engagement as would occur to those skilled in the art.

Providing the reflective surface 12 in a removably engageable mode allows the optics and reflected image 22 to be customized for the job at hand. Using the adhesive 24 or other means of engagement of the reflective surface 12 adjacent to the distal end 11, the reflective surface may be engaged which may have one or a combination of optical reflective properties including, image magnification optical properties, wide angle optical properties, corrective vision properties for users who wear glasses, or a split image yielding two angles reflecting two portions of the mouth adjacent to the distal 11 end of the retractor 14.

In this preferred mode of the device 10 employing means for removable engagement of a reflective surface 12, the device 10 can be made available in kits, or catalogs, featuring a plurality of different reflective surfaces 12, each engageable with any of a plurality of optical reflective properties. Such may include one or a combination of reflective surfaces at increments of angles from of a plurality of angles of engagement relative to the retractor 14 surface adjacent to the distal end 11, at increments of magnification or reduction of the image reflected, at increments of wide angle properties in the reflection, and in increments of vision correction for the reflective image to obviate corrective lenses of the user. Such a plurality of individual reflective surfaces, engageable to a dental retractor 14 as depicted, allows for great customization of the reflected image for the user. Additionally, the removably engageable reflective surfaces 12 also allow for retrofit of any type of dental retractor and not just as shown in the drawings. Such dental retractors may be straight, curved, or in any shape dental professionals may already be employing in their practice. In use, the user would choose the appropriate type of reflective surface 12 for their individual needs and engage it to the distal end of the retractor, thereby customizing the reflected image 22 for the user such as the surgeon, for the individual operation being performed. For instance, magnification might be a great aid in one type of surgery, whereas an unaltered reflection may be preferable to another professional or in another type of operation with the same professional.

Differing angles of reflection are an especially useful feature and can be provided by provision of the reflective surface 12 as in FIG. 6 where the rear side 26 angles relative to the reflective surface 12 and thereby places the reflective surface 12 when engaged to a dental retractor 14 at a different angle than the planar surface adjacent to the distal end 11 of any retractor being employed. While shown as adhesive 24 in FIG. 5 which would be convenient, FIG. 7 shows another means for removable engagement in the form of a bayonet type mount 28 on the back surface of the reflective surface 12 and a receiving cavity 30 on the distal end 11 of the retractor 14.

Additionally, in a preferred mode of the device 10 in combination with the reflective surface 12, as depicted in FIG. 1a, the device 10 may have an engaged or engageable light source. Particularly preferred would be a light-emitting diode (LED) 34 to provide illumination directed at the area of the mouth to be reflected in the reflective surface 12. The LED 34 may also be removably engageable to the retractor 12 and may employ a lens adapted to focus light on the area of the mouth or on the reflective surface 12, or both, to better provide the user with a reflection in an otherwise dark mouth. LED's 34 are available in a very thin configuration and may be employed with adhesive attachments and provided herewith in the kit of reflective surfaces 12. In kit form the lens 36 may be provided with differing lighting outputs to form a small spotlight or providing a wide angle of light to the mouth.

Finally, as shown in FIG. 1a, a means for suction of liquid collecting in the mouth adjacent to the site of the surgery and distal end 11 of the retractor 14 may be provided in combination with the other components. Such a means for liquid collection would employ a conduit 40 formed upon or integral to the body of the retractor 14 which will commentate with a collection aperture 42 at the distal end 11 of the retractor 14. The aperture 42 is positioned on the retractor 14 such that when the retractor 14 is engaged with the patient's mouth at its distal end 11, the aperture 42 would be lower than the reflective surface 12 in the mouth. The other end of the conduit 40 is engaged using a nipple or other engagement means on the retractor 14, to connect it to the suction system available in most dental offices. When so engaged, the aperture 42 will drain the mouth and serve to maintain fluid in the mouth, below the level of the mirrored surface 12 to aid in maintaining it as viewable.

The method and components shown in the drawings and described in detail herein disclose arrangements of elements of particular construction, and configuration for illustrating preferred embodiments of structure of the present dental retractor device with a reflective surface. It is to be understood, however, that elements of different construction and configuration, and using different steps and process procedures, and other arrangements thereof, other than those illustrated and described, may be employed for providing a surgical retrieval device and method in accordance with the spirit of this invention.

As such, while the present invention has been described herein with reference to particular embodiments thereof, a latitude of modifications, various changes and substitutions are intended in the foregoing disclosure, and will be appreciated that in some instance some features of the invention could be employed without a corresponding use of other features, without departing from the scope of the invention as set forth in the following claims. All such changes, alternations and modifications as would occur to those skilled in the art are considered to be within the scope of this invention as broadly defined in the appended claims.

What is claimed is:

1. In a dental retractor having a proximate end for hand engagement and distal end for engagement in the mouth of a patient, an imaging apparatus comprising:
a reflective surface;
means for engagement of said reflective surface to a mounting surface adjacent to said distal end of said retractor;
whereby said retractor when engaged in an as-used position in the mouth of a patient, to said retractor.

2. The dental retractor of claim 1 additionally comprising:
said means for engagement of said reflective surface being removably engageable;
said reflective surface being one from a plurality of reflective surfaces available from a kit;
said plurality of reflective surfaces having individual members of said kit, said members having one or a combination of varying optical properties for reflected images displayed on said reflective surface from a group of optical properties including angle of said reflective surface relative to said mounting surface, magnification of said reflected image, and a wide-angle of said reflective image.

3. The dental retractor of claim 1 additionally comprising:
said means for engagement of said reflective surface being adhesive whereby retractors lacking said reflective surface may be retrofitted with said reflective surface.

4. The dental retractor of claim 1 additionally comprising:
means for rotational engagement of said proximate end of said retractor to said distal end.

5. The dental retractor of claim 2 additionally comprising:
means for rotational engagement of said proximate end of said retractor to said distal end of said retractor.

6. The dental retractor of claim 3 additionally comprising:
means for rotational engagement of said proximate end of said retractor to said distal end of said retractor.

7. The dental retractor of claim 1 additionally comprising:
said distal end having a tip;
a conduit communicating at a first end with an aperture located on said retractor at a position between said reflective surface and said tip;
means for engagement of an other end of said conduit to a source of suction; and
whereby said aperture, with said retractor having said tip engaged in the mouth of a patient in an as-used position, will drain fluid from said mouth and maintain said fluid substantially at a level of said aperture to maintain said reflected image on said reflective surface substantially unobstructed by said fluid.

8. The dental retractor of claim 2 additionally comprising:
said distal end having a tip;
a conduit communicating at a first end with an aperture located on said retractor at a position between said reflective surface and said tip;
means for engagement of an other end of said conduit to a source of suction; and
whereby said aperture, with said retractor having said tip engaged in the mouth of a patient in an as-used position, will drain fluid from said mouth and maintain said fluid substantially at a level of said aperture to maintain said reflected image on said reflective surface substantially unobstructed by said fluid.

9. The dental retractor of claim 3 additionally comprising:
said distal end having a tip;
a conduit communicating at a first end with an aperture located on said retractor at a position between said reflective surface and said tip;
means for engagement of an other end of said conduit to a source of suction; and
whereby said aperture, with said retractor having said tip engaged in the mouth of a patient in an as-used position, will drain fluid from said mouth and maintain said fluid substantially at a level of said aperture to maintain said reflected image on said reflective surface substantially unobstructed by said fluid.

10. The dental retractor of claim 4 additionally comprising:
said distal end having a tip;
a conduit communicating at a first end with an aperture located on said retractor at a position between said reflective surface and said tip;
means for engagement of an other end of said conduit to a source of suction; and
whereby said aperture, with said retractor having said tip engaged in the mouth of a patient in an as-used position, will drain fluid from said mouth and maintain said fluid substantially at a level of said aperture to maintain said reflected image on said reflective surface substantially unobstructed by said fluid.

11. The dental retractor of claim 5 additionally comprising:
said distal end having a tip;
a conduit communicating at a first end with an aperture located on said retractor at a position between said reflective surface and said tip;
means for engagement of an other end of said conduit to a source of suction; and
whereby said aperture, with said retractor having said tip engaged in the mouth of a patient in an as-used position, will drain fluid from said mouth and maintain said fluid substantially at a level of said aperture to maintain said reflected image on said reflective surface substantially unobstructed by said fluid.

12. The dental retractor of claim 6 additionally comprising:
said distal end having a tip;
a conduit communicating at a first end with an aperture located on said retractor at a position between said reflective surface and said tip;
means for engagement of an other end of said conduit to a source of suction; and
whereby said aperture, with said retractor having said tip engaged in the mouth of a patient in an as-used position, will drain fluid from said mouth and maintain said fluid substantially at a level of said aperture to maintain said reflected image on said reflective surface substantially unobstructed by said fluid.

13. The dental retractor of claim 1 additionally comprising:
means for illumination positioned adjacent to said distal end of said retractor; and
said means for illumination projecting light upon one or both of said reflective surface and said mouth adjacent to said reflective surface.

14. The dental retractor of claim 2 additionally comprising:
means for illumination positioned adjacent to said distal end of said retractor; and
said means for illumination projecting light upon one or both of said reflective surface and said mouth adjacent to said reflective surface.

15. The dental retractor of claim 3 additionally comprising:
means for illumination positioned adjacent to said distal end of said retractor; and
said means for illumination projecting light upon one or both of said reflective surface and said mouth adjacent to said reflective surface.

16. The dental retractor of claim 4 additionally comprising:
means for illumination positioned adjacent to said distal end of said retractor; and
said means for illumination projecting light upon one or both of said reflective surface and said mouth adjacent to said reflective surface.

17. The dental retractor of claim 5 additionally comprising:
means for illumination positioned adjacent to said distal end of said retractor; and
said means for illumination projecting light upon one or both of said reflective surface and said mouth adjacent to said reflective surface.

18. The dental retractor of claim 6 additionally comprising:
means for illumination positioned adjacent to said distal end of said retractor; and
said means for illumination projecting light upon one or both of said reflective surface and said mouth adjacent to said reflective surface.

19. The dental retractor of claim 12 additionally comprising:
means for illumination positioned adjacent to said distal end of said retractor; and
said means for illumination projecting light upon one or both of said reflective surface and said mouth adjacent to said reflective surface.

20. The dental retractor of claim 19 additionally comprising:
said reflective surface being a mirror.
